(19) United States
(12) Patent Application Publication
(10) Pub. No.: US 2007/0288337 A1
(43) Pub. Date: Dec. 13, 2007

(54) METHOD FOR TYING THE SALE OF A PROPORTIONAL OWNERSHIP RIGHT IN A LODGING FACILITY TO A LIMITED USE RIGHT IN A RECREATIONAL PROPERTY

(76) Inventor: Ray Kachel, Koloa, HI (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/745,874

(22) Filed: May 8, 2007

Related U.S. Application Data
(60) Provisional application No. 60/746,737, filed on May 8, 2006.

(51) Int. Cl. G06Q 40/00

(52) U.S. Cl. 705/35

(57) ABSTRACT

Aspects of the present invention describe methods for associating proportional ownership interest in a property to limited use rights in recreational property. The method comprises acquiring and devising use rights in a property into two or more proportional ownership use rights, wherein each proportional ownership use right is devised for a standard time period. Further, comprising associating an initiation fee for a limited use right in a recreational property with each purchase of each proportional ownership use right in the property. Further, associating each of proportional ownership use rights in the property with a limited use right in the recreational property, wherein costs of associating the proportional ownership use right in the property with the limited use right in the recreational property includes a yearly fee. Lastly, comprising providing a predetermined level of use of the recreational property to a purchaser of the proportional ownership use right in the property.

### REFERENCE TO RELATED APPLICATIONS

This application claims priority to provisional application No. 60/746,737 titled “Method for Tying Sale of a Proportional Ownership Right in a Lodging Facility to a Limited Use Right in a Recreational Property” filed on May 8, 2006, attorney docket no. 187741/US, which is hereby incorporated by reference herein in its entirety.

### FIELD OF THE INVENTION

This invention relates, in general, to proportional ownership in a lodging facility, and more particularly to tying the sale of a proportional ownership right in an open lodging facility to a limited use right in a recreational property.

### BACKGROUND

Revenue generated from amenities of recreational properties or facilities are generally limited to traditional clientele such as tourists, locals and homeowners. Often times the total amount of potential use and revenue of a recreational property is not maximized by traditional clientele. For example, a golf course, open to the public, may have a maximum number of tee times that may be purchased over the course of a year. Rarely are the maximum number of tee times utilized by traditional clientele. Hence, a portion of available tee times go unused. A solution is needed for filling the unused tee times by providing a new source of clientele.

### SUMMARY OF THE INVENTION

Aspects of the present invention describe a method for associating proportional ownership interest in a property to a limited use right in a recreational property. The method comprises acquiring a property and devising use rights in the property into two or more proportional ownership use rights, wherein each proportional ownership use right in the property is devised for a standard time period. The method further comprises associating an initiation fee for a limited use right in a recreational property with each purchase of each proportional ownership use right in the property. Further, associating each of proportional ownership use rights in the property with a limited use right in the recreational property, wherein a cost of associating the proportional ownership use right in the property with the limited use right in the recreational property includes a yearly fee. Lastly, the method comprises providing a predetermined level of use of the recreational property to a purchaser of the proportional ownership use right in the property.

Additional aspects of the present invention describe a method for providing a limited use right in a recreational property. The method comprises determining a use time period for the limited use right in the recreational property wherein the use time period is based on a predetermined number of days of use in the recreational property over a year timeframe. The method further comprises associating an initiation fee for the limited use right in the recreational property wherein the initiation fee is a function of the use time period. Further, associating an annual dues fee for the limited use right in the recreational property wherein the annual dues fee is a function of the use time period. Lastly, the method comprises providing the limited use right to a user for the use time period.

These summarized aspects of the present invention and others are further described in the detailed description provided below.

### BRIEF DESCRIPTION OF THE DRAWINGS

FIG. 1 is a block diagram illustrating a recreational facility management system according to one embodiment of the invention, the system including a facility utilization system and a data store of recreational facility and lodging facility contracts; and

FIG. 2 is a flow diagram illustrating a method for associating a lodging facility with a recreational facility.

### DETAILED DESCRIPTION OF EMBODIMENTS ON THE INVENTION

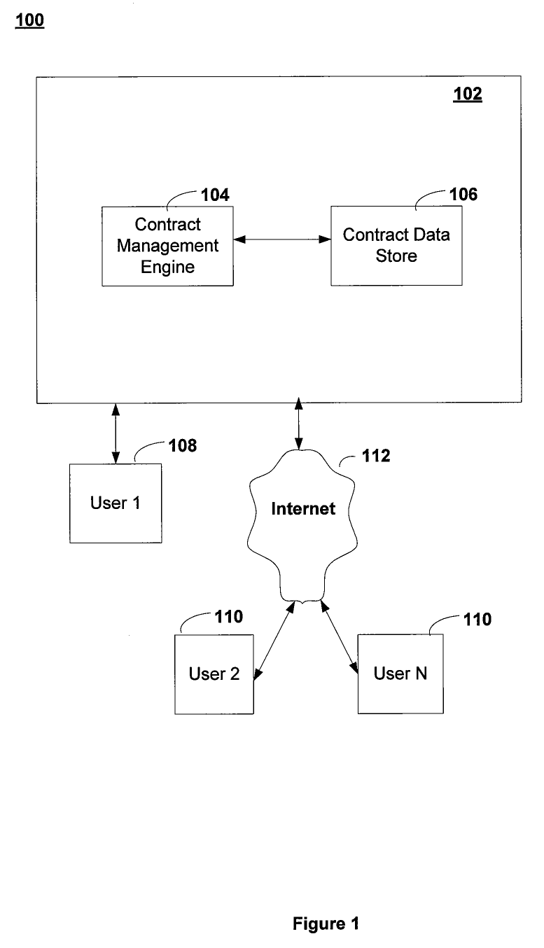

The following description refers particularly to methods for associating the sale of an interest in real property to a limited use right in a recreational property or facility. However it should be appreciated that aspects of the invention are applicable to a broad array of acquiring limited use rights in a recreational facility such that the sale of an interest in real property is not required. FIG. 1 is a block diagram illustrating a recreational facility management system 100 according to one embodiment of the invention, the system 100 includes a contract management engine 104. The contract management engine 104 maintains relationships and contracts between recreational facilities and lodging facilities. For example, lodging facility A may have purchased limited use rights to recreational facility B's golf course. The details of such a contract may be managed by contract management engine 104. Recreational facility management system 100 also includes contract data store 106. Contract data store 106 hosts information relating to contracts between lodging facilities and recreational facilities. For example, the contract details between lodging facility A and recreational facility B may be stored in contract data store 106. Contract data store 106 is in communication with contract management engine 104, permitting engine 104 to retrieve and store information within contract data store 106.

In one embodiment of the system, users 108 may be coupled to the system 100 locally such as a serial connection, a local area network or some other connection such as a wireless network. Additional users 110 may be coupled to the system from a remote location, such as a wide area network or the Internet 112. Various levels of access to the system 100 may be provided through a password and user ID system as is known in the art. The system and related methods described below, in one example, are implemented as executable code residing on one or more servers. Application packages useful for implementing the present invention, in one example, may include Microsoft Windows 2000 Server™, Microsoft VisualStudio 6.0 Enterprise (Server Pack 4.0)™, Microsoft WAST (Web Application Stress Tool)™, Seagate Crystal Reports 8.5 (Developer Edition)™, and SQL 7.0 (Service Pack 2.0)™. Hardware useful in implementing the present invention, in one example, may include Intel™ Core Due™ and AMD™ Athlon™ X2 based machines with 256 MB to 2 GB RAM, and from 50 GB to 500 GB hard drives each. The application packages and hardware are not intended to limit the scope of the invention as defined in the claims, as the application packages and hardware may be substituted to implement the present invention by one of ordinary skill in the art.

In one embodiment of the present invention, a method includes one or more recreational properties, such as: a golf course, tennis facility, winter sports facility, automobile racing facilities, amongst others. It is to be appreciated that a recreational property may include any property, real or personal, that is used for a recreational activity such as golf, tennis, skiing, fishing, scuba diving, hang gliding, sky diving, flying, sailing, boating, kayaking, sun bathing, swimming, diving, cycling, hunting, shooting, racing, photography, musical pursuits amongst others. Such a listing of recreational properties are merely examples and not a complete list. One of skill in the art will appreciate that other recreational properties are within the scope of the present invention.

In another embodiment of the present invention additional methods further include the development of one or more multi-unit real property lodging facilities, such as homes, town homes, condos, apartments, cottages, cabins and the like. A lodging facility may have any desired proportional ownership structure such as single owner, corporate owner, fractional ownership, timeshare owner, vacation rentals, vacation weeks or otherwise. The lodging facility may be located proximate to, remote or elsewhere with respect to the location of the recreational property. In an example, a lodging facility can be situated on or near a golf course, private beach, ski resort, or other locales. Alternatively, the lodging facility can be situated within walking, driving, sailing, or other distance from an associated recreational property.

The lodging facility and/or the recreational property can be separately owned and/or operated. In one embodiment, ownership interest in the recreational property is independent from ownership interest in the associated lodging facility. In other embodiments, the recreational property and the lodging facility may share ownership interest with a mutual entity or entities. In another embodiment, ownership and/or management of the lodging facility, the recreational property and/or other properties may be joint, separate or otherwise established. The lodging facility and/or the recreational property can each be established for any lawful purpose.

Various embodiments of the present invention may utilize one or more contracts to establish legal mutually beneficial relationships between proportional owners of real property, actual owners of the real property and owners of an associated recreational property. For example, a contract may exist between a fractional owner of a condominium, the real persons in interest with respect to the condominium and the owners of a golf club. In one embodiment of the present invention, proportional ownership in the real property may be structured in any desired form such as a fractional ownership, time share, vacation rental or otherwise.

In one embodiment of the present invention, a contractual relationship is established between a proportional owner of a use right in the property (e.g., lodging facility) and the recreational property. Such a contractual relationship enables the proportional owner to enjoy the facilities, amenities and benefits of membership in a the recreational property, while removing them from financial and other responsibilities associated with club equity memberships.

The term “property” in which the proportional ownership use right can be established may also be referred to as the “lodging facility.” However, under some circumstances, the property may not include a lodging facility. An example may be a campground or a recreational vehicle (hereinafter “RV”) park.

In an example, a proportional owner of a lodging facility may divide their limited use right over one or more periods of time. For example, if a proportional owner of a timeshare, condominium, vacation rental or fractional ownership owns 1/52 of the lodging facility, they may receive a tee time for up to two players for each day that the owner remains in the lodging facility. In this example, the limited use right was be valid for 7 days. In one embodiment, the occupation of the lodging facility may be split up over differing period of time, such that the time in the lodging facility is not seven consecutive days. Hence, the days where tee times are provided would not be limited to seven consecutive days as well. For example, the proportional owner may choose to spend four consecutive days in the lodging facility over Memorial Day weekend, followed by the remaining three days spent over Labor Day weekend. The tee times may also follow the split in lodging occupation over two distinct period of time. In an additional embodiment, the tee times may have restrictions as to time of day, whether a cart fee is included, amongst others. Additional conditions and restrictions may also be defined to the limited use right in the recreational property.

The proportional owner's use rights in the recreational property may additionally include use rights to additional or secondary facilities such as swimming pools, tennis court, spas amongst others. These rights may be established upon the proportional owner of the lodging facility entering into a separate contract with the recreational property. Further, these rights may be restricted to the extent or duration of the proportional owner's use rights in the lodging facility. In other words, as long as the proportional owner has proportional use rights in the lodging facility, the proportional owner may also maintain their use rights in the secondary recreational facilities. As stated above, there is no requirement that the use rights of secondary facilities be for consecutive days. If the proportional owner splits their time at the lodging facility between Labor Day and Memorial Day weekend, the use rights to the secondary facilities may also be split over these two weekends.

In another embodiment, a contract between the proportional owner and the recreational property may include provisions for annual dues and initiation fees. In one embodiment, annual dues may be priced significantly less than the fees the public would encounter to use the recreational property. In an example, assume green fees for a round of golf on the recreational property costs $150/person. The contract may be structured such that for $150/year the proportional owner, and an additional person, is able to play golf each day that corresponds to their use rights in the lodging facility. Should the proportional owner play seven days of golf, they would realize a savings in green fees of approximately $1950 for two persons.

On the other hand, such a contractual agreement mentioned above also benefits the recreational property. Such a contract essentially guarantees a cash flow of at least $150 in dues per week, per unit, rain or shine.

It is to be appreciated that other provisions may exist in the contract between the proportional owner and the recreational property. For example, a provision may provide that the failure of a proportional owner to pay the annual renewable dues of $150 may result in the termination of the contract and any use rights associated therewith terminate.

The various embodiments of the present invention also provide a method for simplifying the contractual negotiations between the proportional owner and the recreational property with regard to any initiation fees necessary to obtain use rights in the recreational property. In one embodiment, closing (or at any other desired time or event) on their proportional use rights in the lodging facility, the proportional owner is presented the opportunity to enter into a limited use contract with the recreational property. Desirably, this contract can be front loaded such that the proportional owner need not pay any initiation fees. Unlike common club memberships, where a new club member is often required to pay a substantial initiation or membership fee, for at least one embodiment of the present invention, the proportional owner does not pay any initiation fees to acquire their limited use rights in the recreational property. The fee waiver can also include annual dues and other fees for a given period of time, such as the first year of the owners proportional use rights in the lodging facility or longer. The proportional owner can acquire a pre-paid limited use right in the recreational property at the time of closing (or thereabouts) that is concurrent with any proportional ownership use rights in the lodging facility. The period for which these pre-paid rights can exist may vary, but, generally run concurrent with the first year of use rights in the lodging facility. In other embodiments, however, other periods of pre-paid use rights may exist including, but not limited to, rights in perpetuity—provided (in one embodiment) the proportional ownership rights in the lodging facility also exist in perpetuity.

In another embodiment, acquisition of limited use rights in the recreational property may occur at additional times aside from the time of closing on a proportional ownership in a lodging facility. In other words, the right to purchase a limited use right in a recreational facility is not limited to the property acquisition. For example, a fractional owner in a lodging facility may forego the option for acquiring limited use rights in a recreational facility. However, such a use right in the recreational facility may still be available for any defined period of time beyond the closing of the proportional ownership in the lodging facility. In other words, the proportional owner may be able to add use rights in the recreational facility 10, 20 or 30 years later.

The various embodiments of the present invention further provide for entry into a contractual relationship between the lodging facility title owner (and/or operator) and the recreational property. For example, in exchange for the right to acquire a given quantity of use rights in the recreational property (which can then be passed on to proportional owners), a lodging facility may pay a per unit initiation fee to the recreational property. Desirably, the initiation fee compensates the recreational property for costs, such as development costs for the recreational property, and provides a profit. Additionally and/or alternatively, the lodging facility can pay initiation fees for use of maintenance, improvements or the like. Similarly, it is to be appreciated that for existing recreational properties (such as an existing and established golf course for whom the development fees have already been accrued), initiation fees by and between a lodging facility and a recreational property can be adjusted to any desired amount and to consider any desired need (e.g., on-going maintenance, additional profit for recreational property owners, improvements, expansions, extra profits, or the like). In other words, the collection of initiation fees from a lodging facility may be used for any purpose.

In one embodiment, initiation fees collected from a lodging facility may be rationed, as desired, by the lodging facility and/or the recreational property as set forth in any contractual agreement. For example, the lodging facility and the recreational property may enter into an agreement where a predetermined initiation fee of $26,000 is assessed per the first “n” (a number) of units in the lodging facility that are to be associated with recreational property use rights. This $26,000 per unit initiation fee, could be associated, for example, with the first 50 units in the lodging facility in which proportional use rights are “sold” to one or more proportional owners. This $26,000/unit fee may be structured such that is creates a use right in the recreational property of one to four persons per day, for each day the course is open for proportional use.

Under the above example, each of the first “n” units in the lodging facility may be proportioned into 52 individual weeks per “n” unit. The lodging facility could then devise the $26,000/unit into 52 equal assessments of $500. This assessment may be marketed to prospective proportional owners as a free benefit that comes with the purchase of a one week use right in a unit in the lodging facility. Alternatively, some or this entire $500/unit/week fee may be included as an express or hidden cost in the proportional ownership.

The various embodiments of the present invention further provide that the lodging facility can devise or proportion the use rights in the lodging facility and/or the associated recreational property use rights as they desire. For example, a vacation week arrangement may be used wherein each proportional owner purchases the rights to use the lodging facility for one or more weeks of the year. With this purchase, the proportional owner may also acquire (automatically or by choice) the right to use the recreational facility for the one or more weeks that they have rights to use the lodging facility.

Aspects of the present invention do not limit a lodging facility to proportioning a recreational property use right equally across all 52 weeks. As is often the case in vacation lodging facilities, certain weeks (such as Christmas and Easter) are often more desirable than other weeks. As such, the lodging facility, upon acquiring use rights for a unit for an entire year in the recreational property, can proportion the initiation fee unequally across the weeks of potential use. For example, Christmas week might be worth twice as much as a week in mid-October and thus have associated with it a larger share (e.g., $1000 in the previous example) of the initiation fee. This increased benefit, can be marketed to prospective buyers as a larger free “add-on” or included in the higher costs associated with acquiring the proportional ownership use rights in the lodging facility during a prime vacation period.

Further, the relationship between the lodging facility and the recreational property may use a fixed initiation fee, a variable initiation fee or some combination thereof. For example, the contract between the lodging facility owner/operator and the recreational property can specify that after a given quantity of the use rights in the first “n” number of units in the lodging facility are sold, the initiation fee increases. For example, after 50% of the use rights in the lodging facility for the first 50 of 300 total units are sold, the initiation fee per unit increases from $26,000 to $35,000—thereby reflecting the diminished supply in the number of proportional units available and also reflecting the opportunity costs associated with additional use of the recreational property. Alternatively, in a down market condition, where the perceived market value of proportional use rights in a lodging facility decrease as the “prime” or desirable weeks are sold, the initiation fee for the recreational facility may be structured such that it correspondingly decreases or remains the same.

In an example of a ski resort, the initiation fee in fractional rights to use a dedicated ski lift or ski line at a ski resort may increase as the number of available proportional use rights in the lodging facility decrease in late February. In the alternative, the initiation fee may decrease as the number of proportional use rights in the lodging facility increase in April. Such a fee strategy desirably maximizes the potential fees obtainable for the lodging facility and the recreational property. It is to be appreciated that the contract between the lodging facility and the recreational property may be structured to recognize and capitalize upon perceived market dynamics in a given lodging facility and/or in the recreational property.

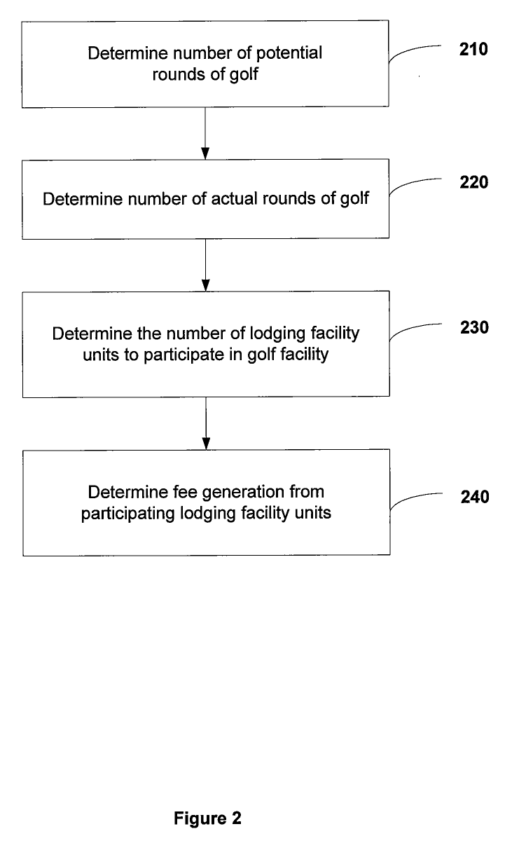

FIG. 2 is a flow diagram illustrating a method for associating a lodging facility with a recreational facility. In one embodiment, the association as described in FIG. 2 may be implemented in the contract management engine. In another embodiment, the contractual information associated with such a contract may be stored in contrast data store 106. In this example, the recreational facility is a golf club. First, a determination is made of the number of available rounds of golf over an entire year (operation 210). Next, a determination is made of the actual or potential use of the available rounds in the recreational property and the fees earned thereby, absent a contractual agreement with a lodging facility (operation 220). Next, a determination is made of the desired number of units in one or more lodging facilities to include in a contractual agreement with the recreational property (operation 230). A determination is made over the annual dues based upon a fractional use of the recreational facility (operation 240). For example, a ratio of two rounds of golf for two persons per one week at the prevailing walk-up market rates. Lastly, a consideration is made to maximize the number of units available in a lodging facility for tying a proportional ownership right to a limited use right in the recreational property in order to obtain a desired profit.

In an example illustrating the method described in FIG. 2, a golf club has 90,000 available rounds of golf for an entire year. Of those available rounds, 35,000 actual rounds of golf are utilized. Traditional distribution of the type of user of the course is broken into three categories: local residents, timeshare/condo/vacational week users and tourists. In this example, no fractional use right members are considered. A traditional percentage of the types of users who utilize the course are also known. Local residents utilize 40% of the actual rounds played per year at an average rate of $40/round. This equates to 14,000 rounds of golf which generate fees of $560,000. Similarly, timeshare/condo/vacational week users utilize 10% of the actual rounds played per year at an average rate of $72/round. This equates to 3500 rounds of golf which generate $252,000 in fees. Lastly, tourists utilize 50% of the actual rounds at played per year at an average rate of $90/round. This equates to 17,500 rounds of golf which generate $1,575,000 in fees. The grand total of fees for the course is $2,387,000. That is, $2,387,000 is the actual revenue for the course, from tee times, if the present invention is not implemented.

In an example where the present invention is used, 50 lodging units may be incorporated into the above model. As previously declared the golf club is able to handle 90,000 rounds per year or 246 rounds per day. At the existing rate of 35,000 rounds per year or 96 rounds per day, the golf course is able to accommodate an additional 150 rounds of golf per day by proportional owners. In other words at least 150 units could be included in an implementation of the invention assuming one round of golf per unit per day.

As declared above, a one-time initiation fee in the recreational property would cost $26,000 per unit. If 50 unites were incorporated into the model, then one-time initiation fees collected by the golf club would be $1,300,000. As previously stated, annual dues would be $150 per unit per proportional week. This would equate to $390,000 in annual dues regardless of how many rounds of golf are actually utilized by the fractional owner of the 50 units. Whether all 50 rounds of golf per day were used or only 10 rounds per day, the recreational facility is still collecting $390,000 in annual dues. When combined with the initiation fee, this results in an increase of $1,690,000 in profit to the recreational property in the first year. With only a maximum of an additional 50 rounds being played per day, the wear and tear on the golf course is minimal.

In one embodiment, the actual number of rounds of golf played by a proportional owner during their week may be three rounds of golf. Further, a proportional owner may only visit the lodging facility once every two years. As such, the maximum addition of 150 proportional owner golf rounds per day may be oversold based upon such statistical use numbers as described herein. For example, if the average unit only utilizes three rounds of golf every two years, than the maximum number of potential units utilizing the golf club may be 700 units. This may result in drastically larger revenue amounts assuming that overselling of units is permissible by contract. Such overuse rights may be adjusted, as desired, to guarantee a given number of tee times being available for a proportional owner in any given week while recognizing that less than 22% of proportional owners would likely exercise a limited use right to a tee time on any given day.

In another embodiment of the present invention, parties other than fractional owners, timeshares and condominium owners in a lodging facility may also be considered. In one example, an owner of a vacation rental home may contract with a recreational facility to provide limited use rights to the recreational facility. In such a situation, the vacation home may be equivalent to a single unit in a larger lodging facility. As such, the vacation home may pay the initial membership fee of $26,000 to the recreational facility just as done with each unit within a larger lodging facility. Additionally, use fees of $150 per week may also be collected by the recreational facility in a similar manner as done with regards to a single unit in a larger lodging facility. From the perspective of the recreational facility, the amount of collected fees and dues is the same with the vacation rental home as with a single unit in a larger lodging facility. From the perspective of the vacation home rental, the owner of the home may market the limited use right in the recreational property as an added benefit to utilizing the vacation rental home. The owner of the vacation rental home may absorb the cost of the fees and dues and offer the use right as a free benefit, or the fees and dues may be added to the cost of staying in the vacation rental home.

In another embodiment, a recreational facility may form a contract with the owner of an individual vacation rental home. Alternatively, a rental company may own or manage multiple vacation rental homes, such that a contract may exist between the recreational facility and the rental company. In such an arrangement the total number of vacation rental homes own or managed by the rental company may be equivalent to the same number of units in a proportional ownership lodging facility.

In another embodiment, additional lodging facilities may contract with a recreational facility to offer a limited use right in the recreational facility. Such facilities may include a campground or RV parks. Under such an embodiment the campground or RV park may contract to purchase a block of golf rounds over the course of year. Such an agreement may permit residents of the campground or RV park to purchase such golf rounds. Many other agreements under this scenario are possible and understood by one skilled in the art. As such, not every scenario is described herein.

In another embodiment, individuals who are not tied to any specific lodging facility may also contract with and utilize limited use rights in a recreational facility. In such an arrangement, individuals may purchase blocks of limited use rights in a recreational facility. For example, an individual may wish to buy a week of golf at a golf club wherein each day of the week provides for a round of golf for one or more persons. In one embodiment, the rounds of golf are used in consecutive days. However, the rounds of golf may also be utilized over differing periods of time. For example, a user may purchase a week of golf providing for seven rounds. The user may live elsewhere but make frequents trips to the area adjacent to the golf club. During each trip the user may chose to utilize a round of golf. In another embodiment, such a user may also choose to purchase longer use rights than a single week. For example, a user may own a second home adjacent to the golf club in which the home is used six months of the year. The user may purchase four weeks of golf to be used in consecutive or non-consecutive days. In such an arrangement the user could use one round of golf each week during the six month residency of the user. In the alternative, the user could play three times a week for eight consecutive weeks. One skilled in the art will appreciate that any combination of use may be utilized.

In another embodiment, reward points may be used to purchase limited use rights in a recreational facility. For example hotels and/or timeshare facilities often provide reward point programs. Such a program permits the use of reward points to redeem them in exchange for goods and services. Such goods and service may include appliances, electronics, free hotels rooms, rental cars and airline tickets amongst other things. A reward point program member is able to accumulate such point for participation in various activities such as staying in a associated hotel, renting an associated car, or flying on an associated airline. As such, it is permissible to redeem reward points toward a limited use right in a recreational facility. For example, a proportional owner may have the option of buying a week or golf for $150 or to redeem 15,000 rewards points. In this embodiment, no limitation should be placed on the type of reward point system being used.

In such an arrangement of using reward points in place of currency, the owner of the recreational facility would still receive currency even though the purchase of the limited use right for the user was in the form of reward points. In such an arrangement, the owner or an agent of the reward points program would reimburse the recreational facility owner with currency.

Through this application golf clubs have been the primary example used for utilizing limited use rights in a recreational facility. As previously stated, aspects of the present invention may be used for numerous additional recreational activities. As such, the invention should not be limited to golf facilities.

In another embodiment, limited use rights in a recreational facility may be split across different recreational activities as well. For example, a proportional owner may divide their time in a lodging facility as four days in January in three days in July. Depending on the geographical location, golf may be unplayable in January. Therefore, division of recreational facilities is possible. As such, a proportional owner may use four of their days in the limited use right for snow skiing in January with the remaining three days spent golfing.

Thus, it is to be appreciated that the various embodiments of the present invention provide a method for tying the sale of a proportional use right in a property, such as a lodging facility, to a limited use right in a recreational property. Under the various embodiments, separate contractual relations can be entered into between a lodging facility owner and a recreational property owner whereby the right to market the limited use right in the recreational property desirably creates a marketing advantage for the developer and/or operator of the lodging facility and wherein the tying of the limited use right in the recreational property to the lodging facility creates a significant, one time, increase in fees and profit of the recreational property. Also, the providing of separate contractual relations between the proportional owner and the recreational property owner removes the lodging facility from any burden or obligation to collect, administer or otherwise deal with annual dues and/or the relationship and terms and conditions existing between a proportional owner and the recreational property owner.

While the present invention has been described herein with reference to various embodiments, features, configurations, and the like, it is to be appreciated that the foregoing description is with respect to only a few of the possible embodiments of the present invention and is not to be construed as limiting the scope of invention. The present invention is to be construed as covering those systems and/or methods described above as well as any other systems and methods which are within the spirit and scope of the following claims and/or any subsequently added or amended claims.

1. A computer implemented method for associating proportional ownership interest in a property to a limited use right in a recreational property, comprising:
acquiring a property;
devising use rights in the property into two or more proportional ownership use rights, wherein each proportional ownership use right in the property is devised for a standard time period;
associating an initiation fee for a limited use right in a recreational property with each purchase of each proportional ownership use right in the property;
associating each of proportional ownership use rights in the property with a limited use right in the recreational property, wherein a cost of associating the proportional ownership use right in the property with the limited use right in the recreational property includes a yearly fee;
providing a predetermined level of use of the recreational property to a purchaser of the proportional ownership use right in the property; and
storing the association of the proportional ownership use right in the property with the limited use right in the recreational property into a computer memory.

2. The method of claim 1, wherein the property comprises a lodging facility and the proportional ownership use right in the property comprises a proportional ownership use right in a unit in the lodging facility.

3. The method of claim 1, wherein the proportional ownership use right in the property comprises at least one of the following:
a) a fractional membership;
b) a time share agreement;
c) a vacation rental; and
d) a condominium membership.

4. The method of claim 1, wherein the property is divided by up to 52 proportional ownership use rights, wherein a proportional ownership use rights is at least seven days.

5. The method of claim 1, wherein the initiation fee is borne by one of the following:
a) a developer of the property;
b) a manager of the property;
c) at least one proportional owner of the property;
d) a fractional owner; and
e) an owner of a vacation rental home.

6. The method of claim 1, wherein the initiation fee is included in a purchase price for the proportional ownership interest in the property.

7. The method of claim 1, wherein the initiation fee is payable for with one or more reward points from a reward points program.

8. The method of claim 7 wherein the initiation fee is payable to the owner of the recreational facility by the owner of the reward points program.

9. The method of claim 1, wherein the limited use right in the recreational property includes use of a golf course.

10. The method of claim 9, wherein the golf course is one of the following types of golf course:
a) private;
b) semi-private;
c) public;
d) equity based; and
e) corporate owned.

11. The method of claim 1, wherein the limited use right in the recreational property includes use of one or more secondary facilities and amenities provided by the recreational property during the time period of the limited use right.

12. The method of claim 11 wherein the secondary facility offers is one of the following types of activity:
a) golf;
b) tennis;
c) alpine skiing;
d) Nordic skiing;
e) sailing;
f windsurfing;
g) scuba diving;
h) snorkeling;
i) auto racing;
j) mountain biking;
k) ice skating;
l) snowshoeing;
m) dog sledding;
n) hang gliding;
o) bungee jumping;
p) four-wheeling;
q) fishing;
r) mountain climbing;
s) hiking;
t) rappelling;
u) basketball;
v) weight lifting;
w) swimming;
x) skate boarding; and
y) flying.

13. The method of claim 1, wherein the property comprises a cruise ship.

14. The method of claim 1, further comprising:
associating a one time fee with the property.

15. The method of claim 1, further comprising:
associating a one time fee with each proportional ownership use right in the property.

16. The method of claim 1, wherein the initiation fee in inversely proportional to a number of proportional ownership use rights available for sale in the property.

17. The method of claim 1, wherein the limited use right in the recreational property is restricted to a predetermined number of proportional ownership use rights in the property.

18. The method of claim 1, wherein the limited use right in the recreational property restricts use of the recreational property by a predetermined criteria.

19. The method of claim 1, wherein the property further comprises use of an automobile and the recreational property provides facilities configured for driving the automobile under race like conditions.

20. The method of claim 1, wherein the number of proportional ownership interests in the property that are associated with the limited use right in the recreational property are greater than the number of available limited use rights to the recreational facility.

21. A computer implemented method for providing a limited use right in a recreational property, comprising:
determining a use time period for the limited use right in the recreational property, the use time period being a number of days of use in the recreational property over a year timeframe;
associating an initiation fee for the limited use right in the recreational property wherein the initiation fee is a function of the use time period;
associating an annual dues fee for the limited use right in the recreational property wherein the annual dues fee is a function of the use time period;
providing the limited use right to a user for the use time period; and
storing the limited use right of the recreational property in a computer memory.

22. The method of claim 21 wherein the use time period is at least seven days.

23. The method of claim 21 wherein the initiation fee is payable with one or more reward points from a reward points program.

24. The method of claim 21 where the use time frame may be used over inconsecutive days.

25. The method of claim 21, wherein the limited use right in the recreational property includes two rounds of golf for each day of the use time period.

26. The method of claim 21, wherein the limited use right in the recreational property includes use of one or more secondary facilities and amenities provided by the recreational property during the use time period.
